(19) United States
(12) Patent Application Publication
(10) Pub. No.: US 2009/0125810 A1
(43) Pub. Date: May 14, 2009

(54) Streamed File System for Optical Disc Applications

(75) Inventor: Hendrik Frank Moll, Geldrop (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/817,507

(22) PCT Filed: Mar. 2, 2006
(86) PCT No.: PCT/IB06/50659

§ 371 Date: Aug. 31, 2007

Related U.S. Application Data
(60) Provisional application No. 60/658,252, filed on Mar. 3, 2005.

(51) Int. Cl. G06F 3/00

(52) U.S. Cl. 715/716

(57) ABSTRACT

An optical disk player (101, 405) can run an application program (406) while also showing an audio/video presentation (402) to a user. In order to ensure uninterrupted viewing of the presentation for the user, the application program must secure application data from the optical disk (113) at the same time as audio/video data is being retrieved. This is facilitated if the audio and video data are stored interleaved together with the application data in a transport stream (111, 203, 306). Preferably the application data is in a format (306) that repeats frequently, so that the application program (406) can pick it up in many different parts of the audio/video presentation (402), without interrupting the audio/video presentation (402). An example of a format that repeats frequently is a carousel.

The invention relates to the field of transferring multimedia content to and from optical storage.

US 2004/0013416 shows an optical disk player that retrieves audio, video and application data from optical disk using an MPEG/MPEG2 format. In MPEG based systems, the head of the drive is busy reading MPEG data from the disc cannot be moved freely during operation. As a result, accessing application data in accordance with this patent document will generally require interruption of any audio/video presentation that a user is experiencing, or alternatively require very large data buffers.

It would be desirable to be able to retrieve audio and video data from an optical disk at the same time as application data, without the user experiencing any interruption of an audio/video presentation.

Preferably, a storage and retrieval format is used that interleaves all types of data into a transport stream, including audio, video and application data. Preferably the application data repeats. An example of a data format that can be used for the application data is a carousel.

The invention will now be described by way of non-limiting example with reference to the drawing in which:

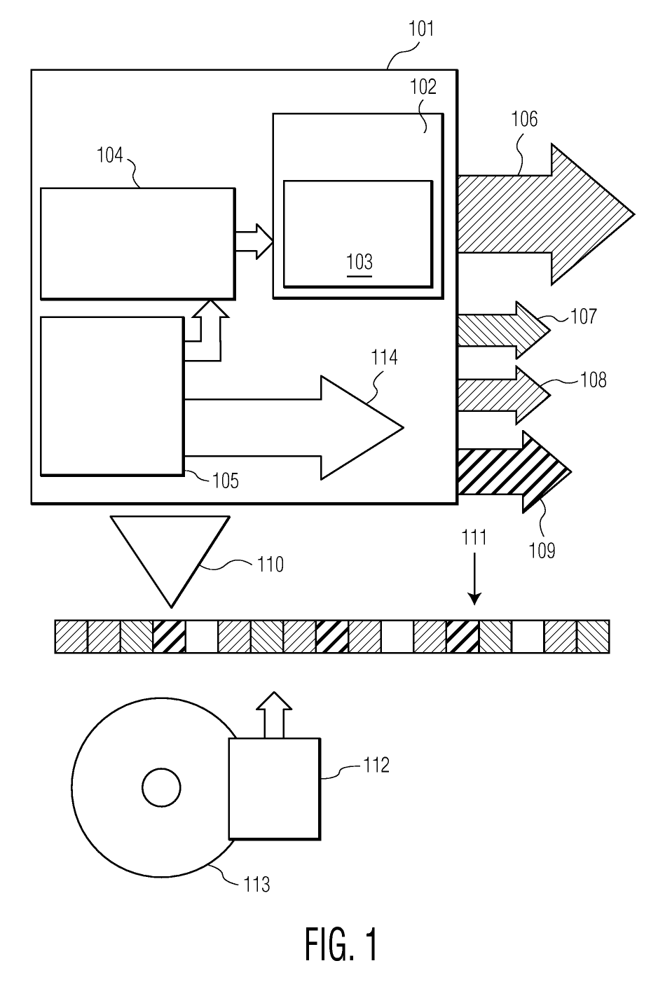

FIG. 1 shows reading a data stream from an optical disk file system to retrieve audio, video, subtitle, and application data.

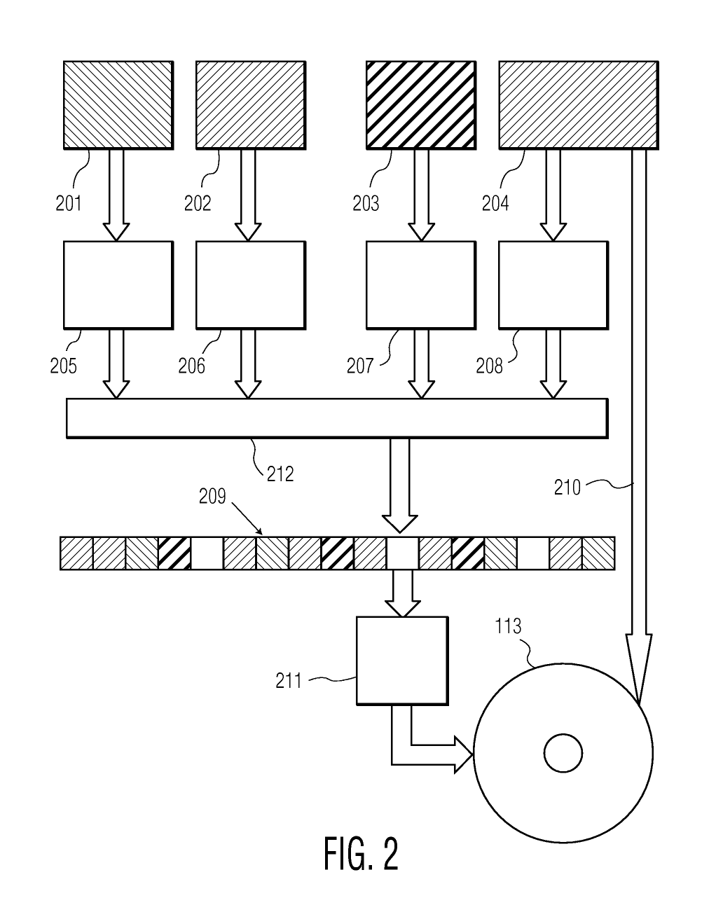

FIG. 2 shows recording a data stream to disk, the data stream including audio, video, subtitle, and application data.

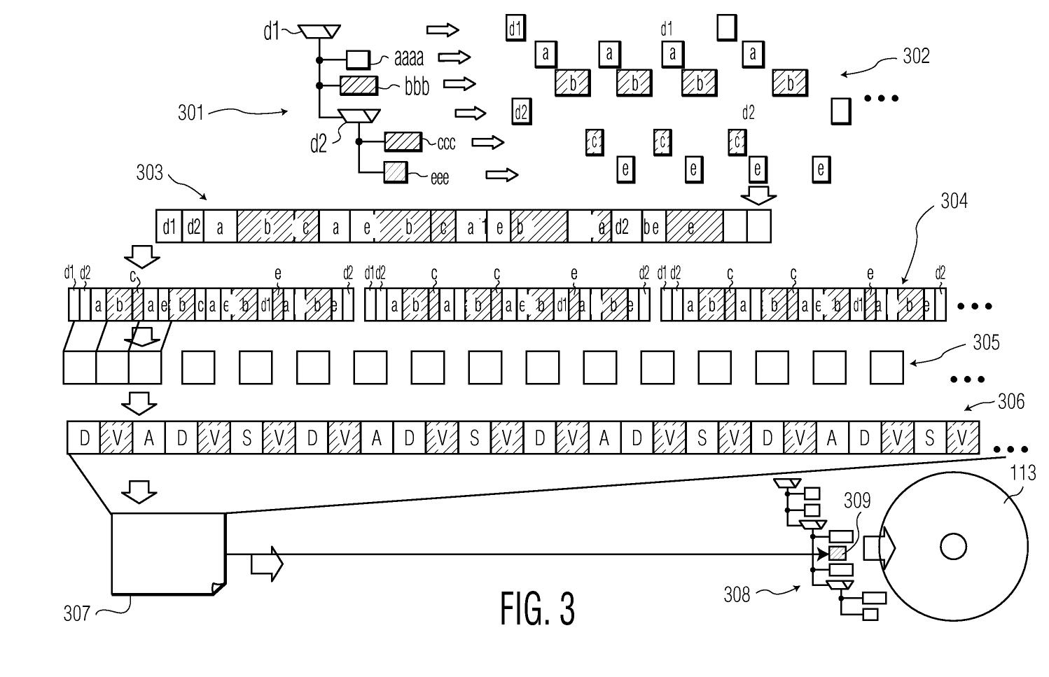

FIG. 3 shows more detail of interleaving application data into a transport stream with audio & visual data.

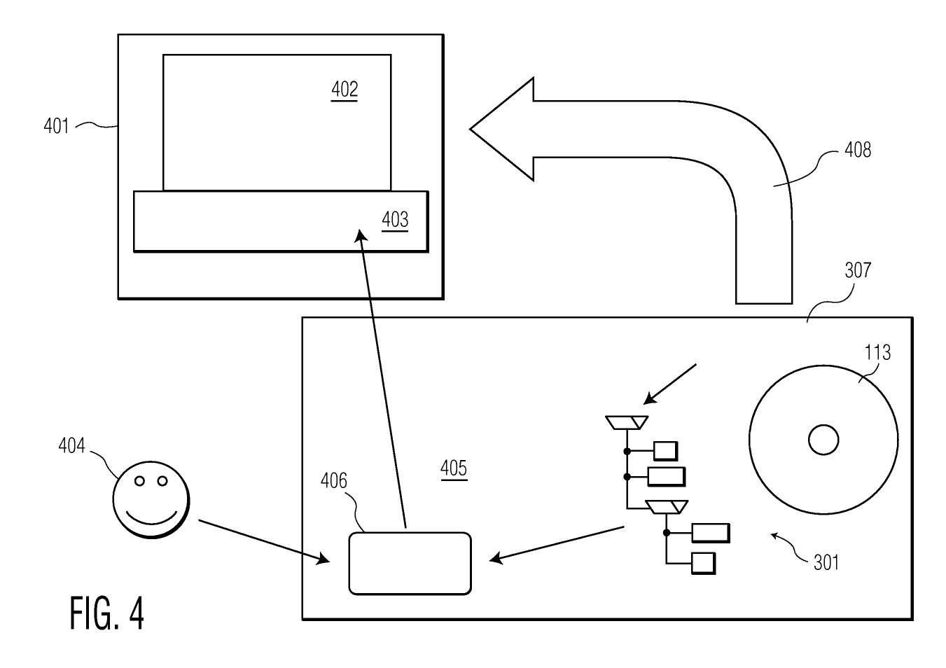

FIG. 4 shows schematically an embodiment of how the invention would look in operation.

The invention is most likely to be useful in optical disk environments, particularly in the blu-ray disk (BD) such as documented in Blu-ray Disc Founders, “The Blu-ray Disc Format,” August 2004. This document can be found at the official web site of the Blu-ray Disc Association—http://www.blu-raydisc.com/assets/downloadablefile/2b_bdrom_audiovisualapplication-12841.pdf.

In BD, transport streams can hold multiple elementary streams. The logical format is a file system, in other words like the DVD (Digital Video Disc) or the Universal Disk Format (UDF) version 2.5. Within that file system, there is room for much more data, so bigger files can be stored. Bandwith is also higher. The data rate can go as high as 25 Mega-bits/s. Transport streams containing high definition (“HD”) video can be read.

BD format standardization for video streams and interactivity includes Java programs that can do things while the user is watching a program. One possible application is to provide extra textual and photographic information on the actors of a movie or the participants of a sports event. This information can be shown on a part of the screen while the video is shown in a scaled way in the remainder of the screen (picture in picture). Another possible alternative is that the information can be shown semi-transparently on top of the video.

The Java program may require additional data while an HD video stream is being read and decoded from the disc. In the UDF format, typically application data and Java byte code are stored in different places from data for audio/video presentations. For data from the audio/video streams, allocation rules—i.e. rules regarding where to put the audio/video stream data on the disc—ensure uninterrupted playback of the audio and video. For Java program data, such rules do not apply. In other words, it cannot be predicted what data an interactive program needs next. Therefore, if the host platform needs application data or additional program code for an application program, it has to interrupt the audio/video presentation to get that data or code. Herein, the term “application data” will be used to mean application data and/or code.

FIG. 1 shows an embodiment of a data retrieval system in accordance with the invention. Data from an optical disk file system 113 is retrieved using a disk head 110 in the form of a transport file 112. The transport file has a stream format as illustrated at 111. In the figure, audio information is shown with vertical hatching; subtitles with horizontal; application data is shown with hatching that slants down from left to right; and video data is shown with hatching that slants up from left to right.

The transport stream 111 goes to demultiplexer 105, which separates out the audio, video and subtitle data 114, which are output to the user at 107, 108, and 109, respectively. The application data is demultiplexed to a unit 104. Unit 104 processes the packets in the elementary stream that contains all the file system data. These packets are generated on recording by a packetizer 208, which will be discussed further below with reference to FIG. 2. The unit 104 retrieves any application code or data files the application needs on request of the application by filtering out the relevant packets and assembling them back into their original files—also shown with respect to FIG. 4.

The decoded files 103 are stored in application memory 102, where they are used for application execution and rendering at 106. Files can be delivered from the stream via streamed packets. Preferably the application data is stored and retrieved in a repeating format, such as the DSM-CC format, formerly used only in broadcasting. The use of MHP/DSM-CC file formats in broadcasting has been documented in Steven Morris, “Interactive TV Web” http://qq.mhp-interative.org/tutorial/mhp/filesystems.shtml (2002).

The DSM-CC format, used for broadcast content, allows application code and data, including a directory tree, to be stored in a format called a “carousel.” The term carousel is used, in analogy with an old-fashioned carnival ride, to indicate that the data is presented in a repeating fashion, as if the receiver were watching a rotating carousel. The advantage of this format is that all necessary data is presented fairly frequently, so that an application program can use it without pausing to wait for new data. It is desirable to store and retrieve application data with respect to an optical disc as part of a transport stream transport stream, where the application is organized within the transport stream in a repeating format, such as the carousel of the broadcast DSM-CC.

The carousel uses a small part of the bandwidth available to the complete transport stream. As an example, 20% of the available bandwidth of a high-definition MPEG2 audio & video stream can be used for the carousel with only a minimal effect on the video quality. This would be 5 Mbit/second for Blu-ray. With a repetition cycle of 32 seconds this would allow 32*5/8=20 Mbyte of data to be available to the application program including some overhead for the protocol used (such as DSM-CC). Using 20 Mbyte of data without a carousel would require the addition of 20 Mbyte of cache memory in each system.

Caching is known in the art prior art. Caching all the data a program might ever need is an alternative solution, but it restricts the maximum size of the data to the size of the cache. For a system to use DSM-CC, some caching of retrieved section of data is also needed. Typically this cache size is related with the size of the files in the carousel and the number of files that a system can retrieve concurrently from the stream. With the example numbers used above, if the data would consist of 100 files of size 100-1000 Kbyte, a buffer of 2 Mbyte would allow 2-10 files to be retrieved at the same time. The choice of the buffer size influences the performance in terms of latency of the carousel.

The exact information that is retrieved from the carousel is under user control via the application program, e.g. using remote control keys.

FIG. 2 shows an embodiment of a device for storing data in accordance with the invention. Audio, video, and subtitle content which are to be used to make up a presentation to a user are encoded in respective encoders at 201, 202, and 203. Application code files are made available at 204. All four types of content and/or data are packetized in respective packetizers at 205, 206, 207, and 208. The resulting packets are multiplexed at 212 to create the transport stream 209. This transport stream becomes transport stream file 211, which is then stored to the optical disk system 113. If there is no need to coordinate audio, video and/or subtitle content, application code files 204 can be provided directly to the optical disk file system 113 at 210. Like the transport stream 111, the stream 209 is preferably organized so that the application data repeats, for instance as a carousel, like that shown in the broadcast standard, DSM-CC.

While FIGS. 1 and 2 are shown as separate devices, they might be housed together in a single device. Typically however what is drawn in FIG. 2 is part of the production process of optical disc and what is drawn in FIG. 1 is part of a optical disc player. In an optical disc system that can play back from disc as well as record data on optical disc both can be included.

FIG. 3 shows more detail of an example of how application data and code may be stored in accordance with the invention.

At 301, is an example of a file structure for some application data and code. The file structure includes files aaa and bbb in directory d1; files ccc and eee in directory d2; and directory d2 in directory d1. This is just an example of a file structure. More or less files might be used. More or less directories might be used. The directories might be nested differently. Those of ordinary skill in the art know how to design file structures as necessary for particular applications.

At 302, the data from the file structure 301 are shown cut into pieces. Directory d1 is shown cut into 2 pieces, both labeled, d1. File aaa is shown cut into four pieces, each labeled a. File bbb is shown cut into four pieces, each labeled b. Directory d2 is shown cut into 2 pieces, each labeled d2. File ccc is shown cut into 3 pieces, each labeled c. File eee is shown cut into four pieces, each labeled e. These numbers of pieces are also only examples. Files or directories might be cut into more or less pieces, in accordance with known DSM-CC technology.

Each piece from 302 is concatenated into a carousel cycle shown at 303. At 304, the carousel cycle is shown repeated three times, forming an elementary stream. Three times is also just an example. More or less repetitions might be desirable depending on the needs of the application.

The elementary stream is packetized to yield packets 305. Again, the number of packets shown is only an example. More or less packets might be used. Those of ordinary skill in the art know how to determine how many packets and what size packets are necessary, in order to make the application work.

At 306, the packets of application data and code (D) are interleaved with packets of video data (V), audio data (A), and subtitle data (S) to form a transport stream. This transport stream is then made into a transport file 307, which becomes a part 309 of a file structure 308. The file structure 308 is then stored in the optical disk file system 113.

FIG. 4 shows an example of an application program using a data stream in accordance with the invention. A display screen is shown at 401. This might be a display screen on a television, or other similar consumer electronics device, such as a PC. The screen 401 is showing two windows, or picture-in-picture displays. The first is a video window 402 where a standard television program might be shown. The second is an application area 403, where image and/or text data from an application might be shown. For instance, biographical information about a movie star might appear under his picture.

An application program 406 resides in an optical disk player 405. The user 404 will typically interact with the application program 406 via a remote control or other similar mechanism, though other user input devices might also be used. The application program will also communicate with the area 403.

In order to support the application 406, the transport file stream 307 is retrieved from the optical disk file system 113. The file structure 301 is reconstructed from the transport stream 307 to support the application program 406.

Audio, video and/or subtitle data are also communicated at 408 to the television or other similar consumer electronics device.

An example of an application area for the invention is High Definition-Digital Video Disks (HD-DVD).

From reading the present disclosure, other modifications will be apparent to persons skilled in the art. Such modifications may involve other features which are already known in the design and use of optical recording techniques and which may be used instead of or in addition to features already described herein. Although claims have been formulated in this application to particular combinations of features, it should be understood that the scope of the disclosure of the present application also includes any novel feature or novel combination of features disclosed herein either explicitly or implicitly or any generalization thereof, whether or not it mitigates any or all of the same technical problems as does the present invention. The applicants hereby give notice that new claims may be formulated to such features during the prosecution of the present application or any further application derived therefrom.

The word “comprising”, “comprise”, or “comprises” as used herein should not be viewed as excluding additional elements. The singular article “a” or “an” as used herein should not be viewed as excluding a plurality of elements. The word “or” should be construed as an inclusive or, in other words as “and/or”.

1. A system comprising:
at least one user interface (401) for presenting audio and video data to a user (404) and for receiving interactive commands from the user;
at least one drive (110) for reading a data storage medium (113) embodying data structures comprising a transport stream file structure (111, 203, 306) including interleaved packets of audio, video, and application data;
at least one processor (104) for performing the following operations:
using the audio and video data from the transport stream to create a presentation (402) for a user; and
using the application data from the transport stream to run an application program (403) for the user, without interrupting the presentation.

2. The system of claim 1, wherein the application data are arranged to appear repeatedly (304) in their entirety as part of the transport stream along with the audio and video data.

3. The system of claim 1, wherein the application and the presentation simultaneously present respective windows on a display screen.

4. The system of claim 1, wherein the transport stream also comprises subtitle data.

5. A data carrier (113) embodying data structures readable by a data processing device and comprising a transport stream file structure (111, 203, 306) including interleaved packets of audio, video, and application data, so that a device utilizing the optical carrier can
use the audio and video data to create a presentation (402) for a user; and
use the application data to run an application program (406) for the user, without interrupting the presentation.

6. The carrier of claim 5 wherein the application data are arranged to appear repeatedly in their entirety (304) as part of the transport stream along with the audio and video data

7. The carrier of claim 5, wherein the transport file stream structure is in accordance with the DSM-CC standard, and stored in accordance with the UDF standard.

8. The carrier of claim 5, wherein the application data is arranged in at least one carousel.

9. The carrier of claim 5, wherein the carrier is an optical disk (113).

10. The carrier of claim 9, wherein the optical disk is a blu-ray disk.

11. The carrier of claim 9, wherein the optical disk is a DVD disk.

12. The carrier of claim 11, wherein the disk is HD-DVD.

13. A method for storing multimedia data comprising:
organizing multimedia data including presentation content and application data into a transport stream (111, 203, 306), in which packets of audio, video and application data are interleaved, so that a device utilizing the optical carrier can use the presentation content to create a presentation for a user; and use the application data to run an application program for the user, without interrupting the presentation; and
saving the transport stream as a transport file to a storage medium.

14. The method of claim 10, wherein the application data are arranged to appear repeatedly in their entirety (306) as part of the transport stream along with the presentation content.

15. The method of claim 11, wherein the application data is organized into a carousel within the transport stream.

16. A method for retrieving multimedia data comprising;
retrieving a transport file (112) from a storage medium (113), the transport file comprising a transport stream file structure (111) in which packets of audio, video, and application data are interleaved, so that a device utilizing the storage medium (113) can use the presentation content to create a presentation (402) for a user; and use the application data to run an application program (406) for the user, without interrupting the presentation;
demultiplexing (105) the application data from the presentation content;
providing the presentation content to a user as a presentation (402); and
providing the application data to an application program and using the data within the application program without interrupting the presentation.

17. The method of claim 13, wherein the application data are arranged to appear repeatedly in their entirety (306) as part of the transport stream.

18. The method of claim 14, wherein the application data is organized as a carousel within the transport stream.

19. A data carrier (113) embodying data structures readable by a data processing device, which data structures comprise a transport stream (111, 203, 306) including presentation content and application data, which application data is repeated (306) sufficiently frequently that a player device (405) interpreting the carrier (113) can run an application program (406) using the application data and play the presentation (402) at the same time, without interrupting the presentation.
